(19) United States
(12) Patent Application Publication
(10) Pub. No.: US 2026/0054362 A1
(43) Pub. Date: Feb. 26, 2026

(54) FASTENING TOOL AND MAGAZINE

(71) Applicant: Nanjing Chervon Industry Co., Ltd., Nanjing (CN)

(72) Inventors: Matthew Rybka, Nanjing (CN); Mingqi Zhou, Nanjing (CN); Ran Lan, Nanjing (CN)

(21) Appl. No.: 19/374,765

(22) Filed: Oct. 30, 2025

Related U.S. Application Data
(63) Continuation of application No. PCT/CN2024/097024, filed on Jun. 3, 2024.

(30) Foreign Application Priority Data
Jun. 16, 2023 (CN) 202310720819.4
May 24, 2024 (CN) 202410659021.8

(51) Int. Cl. B25C 1/06; B25C 1/00

(52) U.S. Cl. CPC B25C 1/06; B25C 1/005

(57) ABSTRACT

A fastening tool includes: a striking assembly including a striker configured to strike a fastener, a transmission assembly configured to drive the striker to move; a housing for supporting the transmission assembly; a motor at least partially disposed in the housing; and a magazine for accommodating fasteners. The magazine includes at least two movable channels in which at least some fasteners move.

### RELATED APPLICATION INFORMATION

This application is a continuation of International Application Number PCT/CN2024/097024, filed on Jun. 3, 2024 through which this application also claims the benefit under 35 U.S.C. § 119 (a) of Chinese Patent Application No. CN 202310720819.4, filed on Jun. 16, 2023, and Chinese Patent Application No. CN 202410659021.8, filed on May 24, 2024, which applications are incorporated herein by reference in their entireties.

### BACKGROUND

A fastening tool in the related art is usually used for fixing a workpiece. The user drills or drives fasteners into the workpiece to fix the workpiece, and each fastener can be used once. The existing fastening tool includes a magazine for storing the fasteners. However, the magazine can only hold a small number of fasteners. The user needs to frequently replenish the fasteners into the magazine, leading to low working efficiency and inconvenience in use. This part provides background information related to the present application, and the background information is not necessarily the existing art.

### SUMMARY

The present application adopts the technical solutions below.

A fastening tool includes: a striking assembly including a striker configured to strike a fastener; a transmission assembly configured to drive the striker to move; a housing for supporting the transmission assembly; a motor at least partially disposed in the housing; and a magazine for accommodating fasteners. The magazine includes at least two movable channels in which at least some fasteners move.

In some examples, the at least two movable channels at least partially overlap in a front and rear direction.

In some examples, the magazine includes a magazine body and a movable assembly configured to separate the at least two movable channels.

In some examples, the movable assembly is movably connected to the magazine body.

In some examples, the movable assembly includes a separator and locking assemblies, and the locking assemblies allow the separator to be switched between a first position and a second position relative to the magazine body.

In some examples, at least some fasteners are configured to move together with the movable assembly relative to the magazine body.

In some examples, the magazine body includes a first opening, the movable assembly includes a second opening and a third opening, and the movable assembly is operable by the user to selectively connect the second opening and the third opening to the first opening.

In some examples, the movable assembly is connected to the magazine body through elastic members.

In some examples, the fastening tool includes a fastener holder for guiding the fasteners to move along a first straight line, where the fastener holder is configured to be selectively connected to one of the at least two movable channels so that the striker is capable of striking the fastener.

In some examples, the fastening tool includes a lifting member, where the fastener has a working state, and in the working state, the lifting member drives the fastener to move in at least one of the at least two movable channels.

In some examples, the at least two movable channels are parallel to each other.

In some examples, the fastening tool includes a power interface connected to a battery pack.

In some examples, the length of the magazine in a front and rear direction is greater than or equal to 163 mm and less than or equal to 245 mm.

In some examples, the locking assemblies are configured to be driven by elastic forces to move.

In some examples, the movable assembly includes a separator, and the separator includes a second accommodation portion and a third accommodation portion for accommodating the fasteners.

A fastening tool includes: a striking assembly including a striker configured to strike a fastener; a transmission assembly configured to drive the striker to move; a housing for supporting the transmission assembly; a motor at least partially disposed in the housing; and a magazine for accommodating fasteners. The fastening tool further includes: a fastener holder for guiding the fasteners to be struck along a first straight line, where the fastener holder includes an input port connected to at least part of the magazine; a lifting member configured to drive the fastener to move so that the fastener is capable of passing through the input port, where the fastener has a working state in which the fastener is subjected to a force from the lifting member and a standby state in which the fastener is not subjected to the force from the lifting member; and a movable assembly configured to drive at least some fasteners to switch to the working state.

A magazine for a fastening tool accommodates fasteners and includes at least two movable channels in which at least some fasteners move.

### BRIEF DESCRIPTION OF THE DRAWINGS

FIG. 1 is a plan view of a fastening tool according to an example of the present application.

FIG. 2 is a perspective view of the fastening tool in FIG. 1.

FIG. 3 is a perspective view of a motor and a transmission assembly of the fastening tool in FIG. 1.

FIG. 4 is a plan view of a striking device of the fastening tool in FIG. 1.

FIG. 5 is a plan view of a magazine of the fastening tool in FIG. 1.

FIG. 6 is a perspective view of a magazine of the fastening tool in FIG. 1.

FIG. 7 is a perspective view of a magazine of the fastening tool in FIG. 1 from another angle.

FIG. 8 is a perspective view of a magazine body of the fastening tool in FIG. 1.

FIG. 9 is a plan view of a movable assembly of the fastening tool in FIG. 1, with fasteners loaded.

FIG. 10 is a perspective view of a movable assembly of the fastening tool in FIG. 1, with fasteners loaded.

FIG. 11 is a plan view of a locking assembly of the fastening tool in FIG. 1.

FIG. 12 is a perspective view of a portion of a fastener holder of the fastening tool in FIG. 1.

FIG. 13 is a bottom view of a magazine of the fastening tool in FIG. 1 with a movable assembly at a first position.

FIG. 14 is a side view of a magazine of the fastening tool in FIG. 1 with a movable assembly at a first position.

FIG. 15 is a bottom view of a magazine of the fastening tool in FIG. 1 with a movable assembly at a second position.

FIG. 16 is a side view of a magazine of the fastening tool in FIG. 1 with a movable assembly at a second position.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

Technical solutions of the present application are further described below in conjunction with drawings and examples.

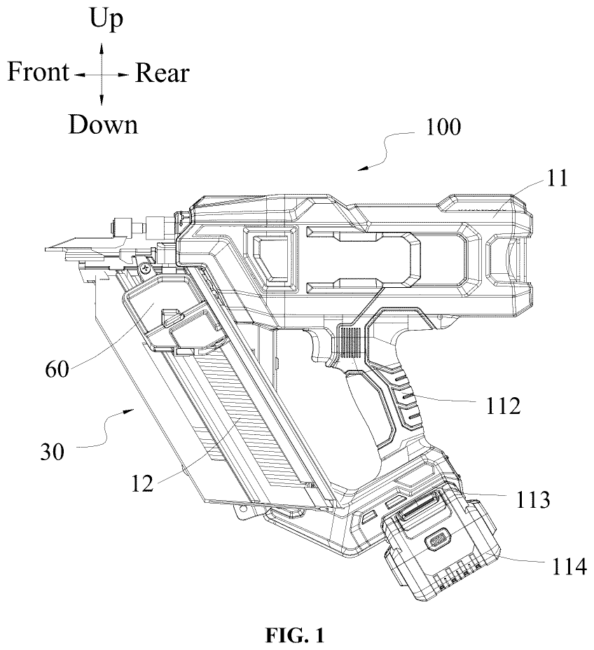

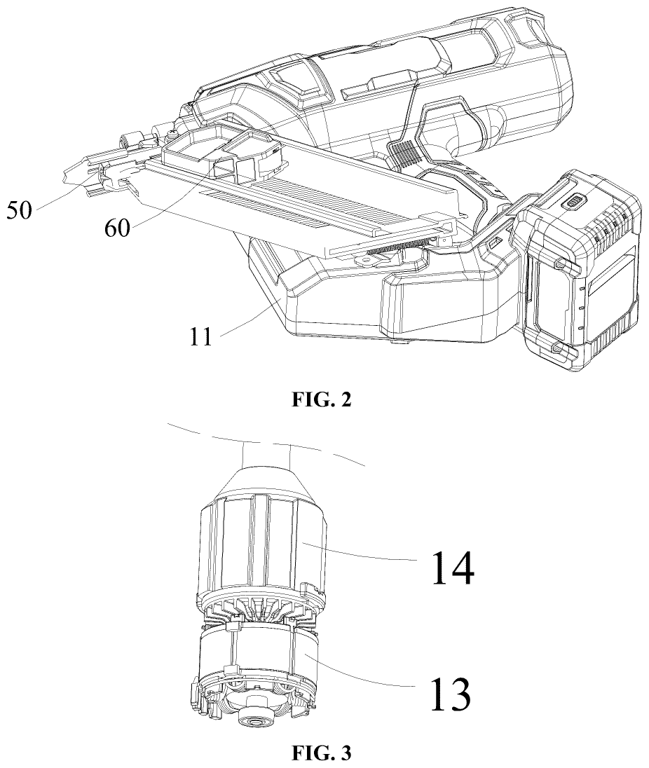

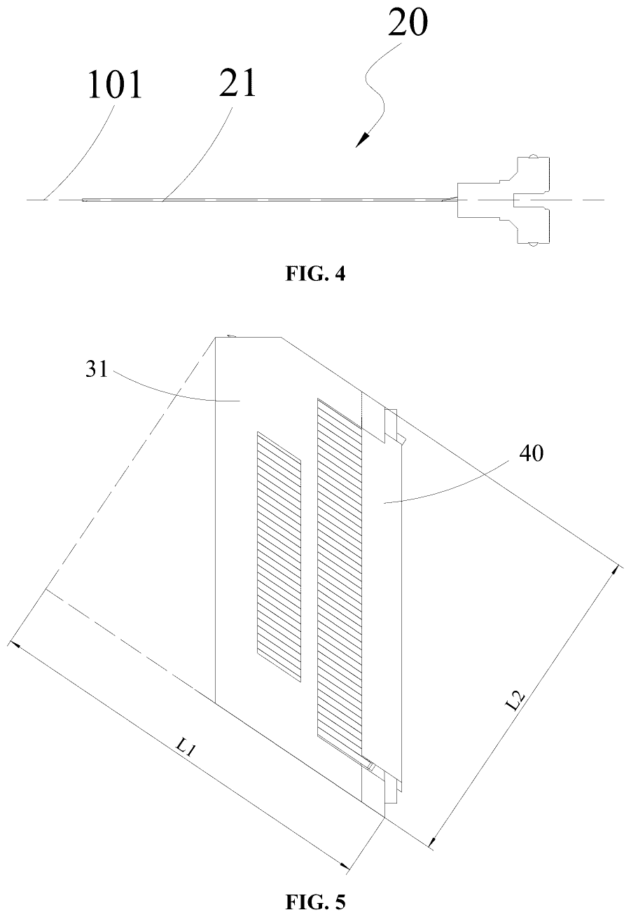

As shown in FIGS. 1 and 2, this example provides a fastening tool 100. The fastening tool 100 provided in this example is a cylinder nail gun. The nail gun may be a spring-loaded nail gun, a single-cylinder nail gun, a dual-cylinder nail gun, a pre-inflated nail gun, or the like, which is not limited here. The fastening tool 100 can generate a striking force on a fastener 12, thereby driving the fastener 12 into a workpiece. The fastening tool 100 includes a housing 11 and a magazine 30. An accommodation space is formed on the inner side of the housing 11. The magazine 30 is used for accommodating fasteners 12, and the magazine 30 is at least partially disposed on the outer side of the housing 11. The fasteners 12 provided in this example are nails. The dimension of the nail may be 15 Ga, 16 Ga, 18 Ga, 23 Ga, 25 Ga, or the like, which is not limited here. The usage angle of the nail may be 0 degrees, 5 degrees, 10 degrees, 15 degrees, 20 degrees, 25 degrees, 30 degrees, or the like, which is not limited here. The housing 11 is further formed with a handle portion 112 that can be held by a user. A main switch is provided on the handle portion 112, and the user controls the start and stop of the fastening tool 100 through the main switch. A power interface 113 is connected to an end of the handle portion 112 and used for connecting a direct current or alternating current power supply. In this example, the power interface 113 is connected to a battery pack 114.

As shown in FIGS. 1 to 3, the fastening tool 100 further includes a striking assembly 20, a motor 13, and a transmission assembly 14. The striking assembly 20, the motor 13, and the transmission assembly 14 are at least partially accommodated in the housing. The housing 11 supports the motor 13 and the transmission assembly 14. The striking assembly 20 includes a striker 21. The motor 13 drives the transmission assembly 14, and the transmission assembly 14 drives the striker 21 to move. The striker 21 is configured to move along a first straight line 101 to output a striking force to the fastener 12. The direction of the first straight line 101 is a direction in which the fastener 12 is driven into the workpiece. After the striker 21 completes one strike, the fastener 12 in the magazine 30 is replenished to the front end of the striker 21, waiting to be driven out by the striker 21. The striking assembly 20 reciprocates to continuously strike the fasteners 12. The structures through which the motor 13 drives the transmission assembly 14 and the striking assembly 20 strikes the fastener 12 are basically the same as those in the existing art, and the details are not repeated here.

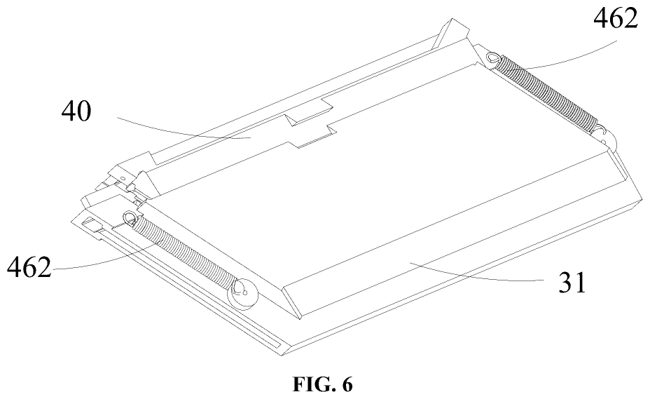

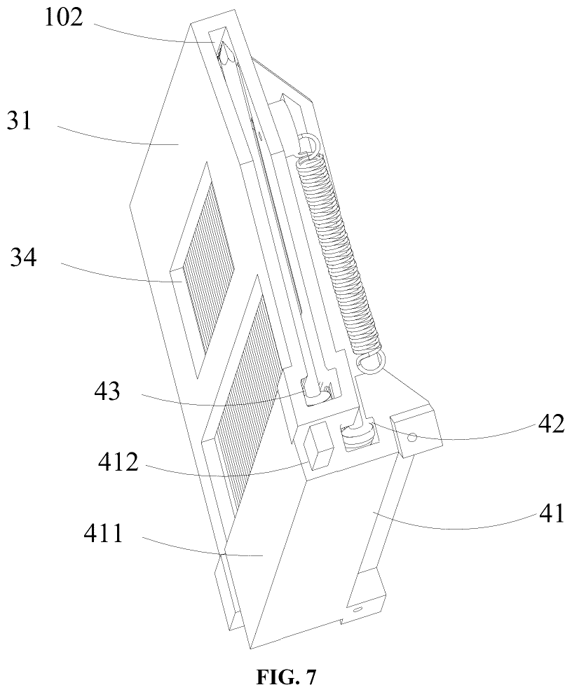

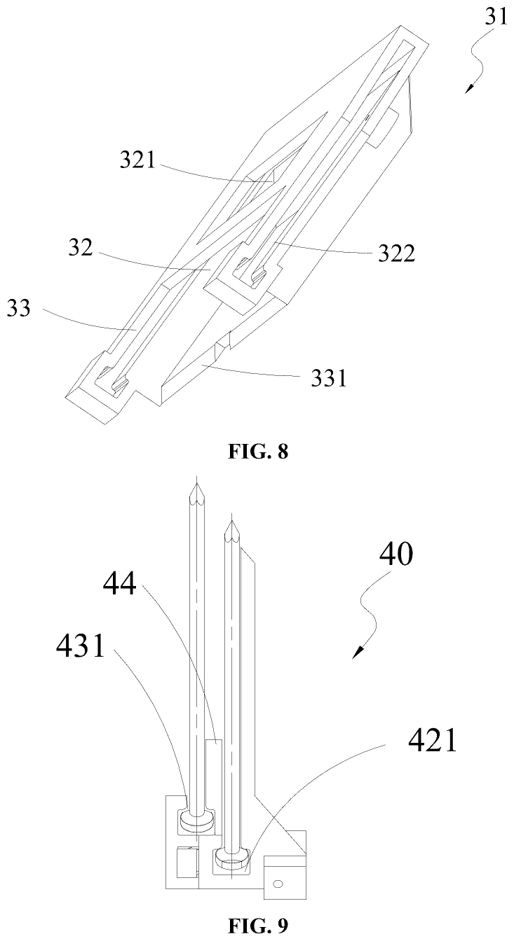

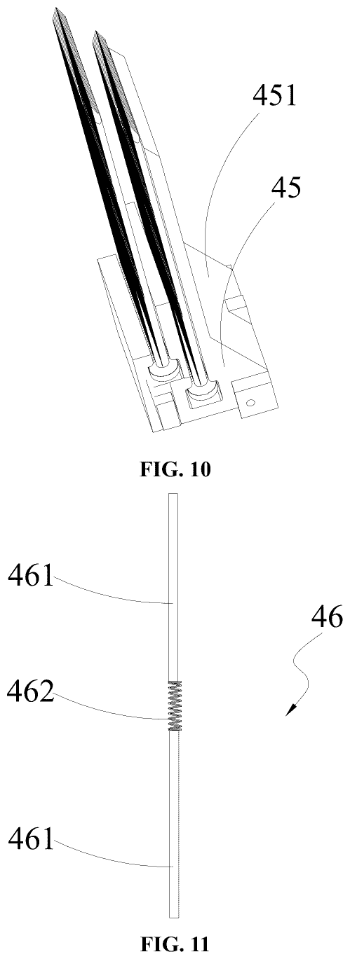

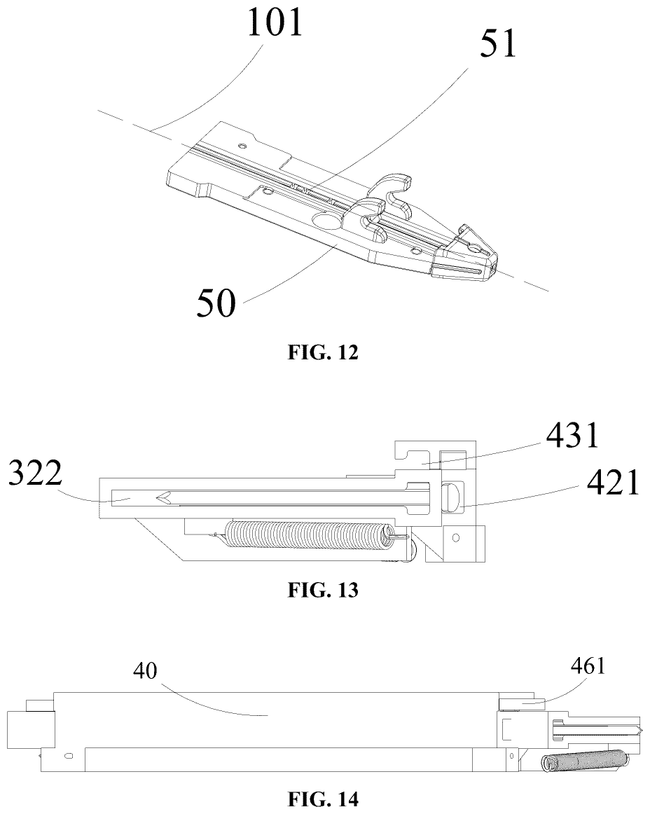

As shown in FIGS. 5 to 10, the magazine 30 includes at least two movable channels 102. The at least two movable channels 102 are configured to allow at least some of the fasteners 12 to move within the at least two movable channels 102. In this manner, the fasteners 12 can move in the at least two movable channels 102. That is, the fasteners 12 can be chambered along at least two movable paths. The movable channels 102 refer to closed, partially closed and partially open, or open channels. Each fastener 12 in one row of fasteners 12 may sequentially pass through the movable channel 102 and be driven out by the striking assembly 20. The conventional fastening tool 100 has only one movable channel 102 for the fasteners 12 to move therein when the fasteners 12 are chambered, and the number of fasteners 12 that can be loaded into the magazine 30 is small. The fasteners 12 can move in the at least two movable channels 102 of the magazine 30, and the magazine 30 can hold a large number of fasteners 12, which is convenient for the user to use without having to frequently replenish the fasteners 12. The at least two movable channels 102 at least partially overlap in the front and rear direction. In this manner, the length of the magazine 30 in the front and rear direction is reduced so that the structure is compact. In this example, the length L1 of the magazine 30 in the front and rear direction after installation is greater than or equal to 163 mm and less than or equal to 245 mm. In some examples, the length L1 of the magazine 30 in the front and rear direction after installation is greater than or equal to 184 mm and less than or equal to 225 mm. In the case where more fasteners 12 are loaded, since the fasteners 12 can move in the at least two movable channels 102 of the magazine 30, the length L2 of the magazine 30 in the up and down direction after installation can be shortened so that the structure is compact. In this example, the length L2 of the magazine 30 in the up and down direction after installation is greater than or equal to 136 mm and less than or equal to 204 mm. In some examples, the length L2 of the magazine 30 in the up and down direction after installation is greater than or equal to 153 mm and less than or equal to 187 mm.

The magazine 30 includes a magazine body 31 and a movable assembly 40. The movable assembly 40 is configured to separate the at least two movable channels 102. The movable assembly 40 separates the at least two movable channels 102, and the two rows of fasteners 12 can move in the two movable channels 102, respectively. The at least two rows of fasteners 12 in the at least two movable channels 102 do not interfere with each other. In some examples, the fasteners 12 loaded into the magazine 30 may form at least two movable channels 102 through the arrangement or shape of the fasteners 12. At least two rows of fasteners 12 are in contact with each other, and no movable assembly 40 is required to separate the rows of fasteners 12. In some examples, at least two rows of fasteners 12 loaded into the magazine 30 form at least two movable channels 102 through the arrangement or shape of the fasteners 12, and at least one row of fasteners 12 is separated from other rows by the movable assembly 40 to form at least one movable channel 102. At least three rows of fasteners 12 are partially in contact with each other and partially do not interfere with each other. In this example, the movable assembly 40 is basically disposed on the rear part of the magazine body 31. In some examples, the movable assembly 40 is basically disposed on the front part of the magazine body 31.

The magazine body 31 includes a first accommodation portion 32 and a first mating portion 33. The first accommodation portion 32 is formed with an accommodation cavity 321, and the accommodation cavity 321 accommodates at least part of the movable assembly 40. The movable assembly 40 includes a separator 41. The separator 41 includes a second accommodation portion 42, a third accommodation portion 43, a partition 44, and a second mating portion 45. The second accommodation portion 42 accommodates some fasteners 12 and forms a part of the movable channel 102. The third accommodation portion 43 accommodates some fasteners 12 and forms a part of the movable channel 102. The cross-sectional shapes of the second accommodation portion 42 and the third accommodation portion 43 basically match the shape of the fastener 12. The cross-sectional shape of each of the second accommodation portion 42 and the third accommodation portion 43 is basically a nail shape. The partition 44 is disposed between the second accommodation portion 42 and the third accommodation portion 43 to separate the two movable channels 102. The first mating portion 33 includes a groove so that the first mating portion 33 can mate with the second mating portion 45. The first mating portion 33 is formed with a first mating surface 331. The second mating portion 45 is formed with a second mating surface 451. The first mating surface 331 and the second mating surface 451 are configured to be inclined surfaces. When the second accommodation portion 42 and the third accommodation portion 43 are both accommodated in the first accommodation portion 32, the first mating surface 331 and the second mating surface 451 abut against each other to limit the position of the separator 41.

The magazine body 31 includes hollow window portions 34. When the movable assembly 40 is at least partially accommodated in the accommodation cavity 321, the window portions 34 allow the fasteners 12 to be visible through the magazine body 31. In this manner, the user can easily observe the degree to which the fasteners 12 are consumed.

The magazine body 31 is mounted on the housing 11. The movable assembly 40 is movably connected to the magazine body 31. In this manner, the user can change the position of the movable assembly 40 relative to the magazine body 31. The movable assembly 40 may be located at different positions relative to the magazine body 31 so that the magazine body 31 and the movable assembly 40 can together form at least part of at least two movable channels 102. The second accommodation portion 42 accommodates and supports some fasteners 12, and the third accommodation portion 43 accommodates and supports some fasteners 12. In this manner, the fasteners 12 can move together with the movable assembly 40 relative to the magazine body 31. The separator 41 includes an operating portion 411. The operating portion 411 is operated by the user to change the position of the separator 41.

The movable assembly 40 includes locking assemblies 46. The locking assemblies 46 allow the separator 41 to be switched between a first position and a second position relative to the magazine body 31. The locking assembly 46 has a locking state and an unlocking state. When the locking assemblies 46 are in the locking state, the locking assemblies 46 prohibit the separator 41 from moving relative to the magazine body 31, and the position of the separator 41 relative to the magazine body 31 is fixed. When the locking assemblies 46 are in the unlocking state, the locking assemblies 46 allow the separator 41 to move relative to the magazine body 31, and the position of the separator 41 relative to the magazine body 31 can be switched from the first position to the second position or from the second position to the first position. The locking assembly 46 includes operating members 461 and an elastic member 462. The operating portion 411 includes a hole 412. The hole 412 extends basically along the length direction of the operating portion 411. The elastic member 462 is disposed in the hole 412. Two operating members 461 are disposed at two ends of the elastic member 462, respectively. The operating member 461 is basically cylindrical. One end of each of the two operating members 461 protrudes from the hole 412 for user operation, and the other end of each of the two operating members 461 abuts against the elastic member 462. When the user presses the two operating members 461 toward the elastic member 462, the user overcomes the elastic force of the elastic member 462, and the locking assembly 46 enters the unlocking state. When the user releases the two operating members 461, the locking assembly 46 is reset to the locking state under the biasing force of the elastic member 462. The locking assemblies 46 allow the separator 41 to be switched between the first position and the second position relative to the magazine body 31, thereby making the operation safe and quick. The elastic member 462 is specifically a spring. In some examples, the locking assembly 46 may include a buckle, a pin, a trigger rod, a button, a magnetic member, or the like, which is not specifically limited here.

The movable assembly 40 is connected to the magazine body 31 through elastic members 462. The elastic member 462 is a spring, and one or more elastic members 462 are provided. One end of the spring is mounted on the movable assembly 40, and the other end of the spring is mounted on the magazine body 31. The elastic members 462 bias the movable assembly 40 toward the magazine body 31. When the user moves the movable assembly 40 in a direction away from the magazine body 31, the user needs to overcome the elastic forces of the elastic members 462. After the user overcomes the elastic forces of the elastic members 462 to pull the movable assembly 40 backward, the movable assembly 40 moves to a third position.

The first accommodation portion 32 is formed with a first opening 322. The second accommodation portion 42 is formed with a second opening 421. The third accommodation portion 43 is formed with a third opening 431. The cross-sectional shapes of the first opening 322, the second opening 421, and the third opening 431 basically match the shape of the fastener 12. The cross-sectional shape of each of the first opening 322, the second opening 421, and the third opening 431 is basically a nail shape. The movable assembly 40 is operable by the user to selectively connect the second opening 421 and the third opening 431 to the first opening 322. When the second opening 421 is connected to the first opening 322, the user can place one row of fasteners 12 into the second accommodation portion 42 through the first opening 322 and the second opening 421 in sequence, and the movable assembly 40 is located at the first position. When the third opening 431 is connected to the first opening 322, the user can place another row of fasteners 12 into the third accommodation portion 43 through the first opening 322 and the third opening 431 in sequence, and the movable assembly 40 is located at the second position. The user places two rows of nails when the movable assembly 40 is located at the first position and the second position, respectively, and the magazine 30 can accommodate two rows of nails in total. In some examples, the movable assembly 40 includes more than two accommodation portions, and the magazine 30 can accommodate more than two rows of nails in total.

The fastening tool 100 includes a fastener holder 50 for guiding the fasteners 12 to move along the first straight line 101. The fastener holder 50 is configured to be selectively connected to one of the at least two movable channels 102 so that the striker can strike the fastener 12. The fastener holder 50 includes an input port 51. The input port 51 is connected to at least part of the magazine 30 so that the fastener 12 can move from the magazine 30 to the input port 51. The first opening 322 is connected to the input port 51. When the second opening 421 is connected to the first opening 322, the magazine body 31 and the separator 41 together form one movable channel 102 for the fastener 12 to move therein. When the third opening 431 is connected to the first opening 322, the magazine body 31 and the separator 41 together form another movable channel 102 for the fastener 12 to move therein. The first opening 322 can be separately aligned with the second opening 421 and the third opening 431, and the first opening 322 is connected to the input port 51 so that the input port 51 is selectively connected to one of the at least two movable channels 102. In this example, since the position of the separator 41 switches between the first position and the second position, the input port 51 is connected to either one of the at least two movable channels 102 or the other one of the at least two movable channels 102. In some examples, the at least two movable channels 102 may converge at one point so that the input port 51 may be connected to the at least two movable channels 102 at the same time.

As shown in FIG. 1, the fastening tool 100 includes a lifting member 60. The lifting member 60 is operated by the user to arrange the fasteners 12 closely in the magazine 30 in the up and down direction by the elastic force. The elastic force is generated by an elastic member, such as a spring or a coil spring. The lifting member 60 is configured to drive the fastener 12 to move so that the fastener 12 can pass through the input port 51. The fastener 12 has a working state and a standby state. In the working state, the fastener 12 is subjected to the force from the lifting member 60 and is driven by the lifting member 60. In the standby state, the fastener 12 is not subjected to the force from the lifting member 60 and is not driven by the lifting member. The movable assembly 40 can drive at least some fasteners 12 to switch to the working state. In this manner, in the standby state, some fasteners 12 stored in the magazine 30 can quickly switch to the working state for use by the user. In the working state, the fasteners 12 are chambered successively through the nail feeding port 51 so that the user can use the fastening tool 100 to perform operations. In the working state, the lifting member 60 drives the fasteners 12 to move in at least one of the at least two movable channels 102. The fasteners 12 successively pass through the input port 51 and are driven out along the first straight line 101 by the striking assembly 20. In this example, the fasteners 12 are all stored in the magazine 30.

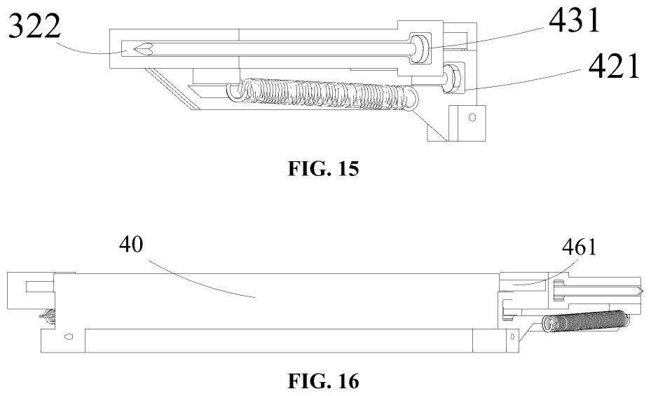

The following describes the entire process of replacing and consuming the fasteners 12 in the fastening tool 100. As shown in FIG. 1, the user pulls the lifting member 60 from above the magazine 30 to below the magazine 30. A side of the magazine 30 facing away from the housing 11 is defined as the outer side, and a side of the magazine 30 facing the housing 11 is defined as the inner side. As shown in FIGS. 13 and 14, the second opening 421 is connected to the first opening 322, and the movable assembly 40 is located at the first position. The third accommodation portion 43 is at least partially located on the outer side of the magazine body 31. The user now loads one row of fasteners 12 into the second accommodation portion 42 through the first opening 322 and the second opening 421. After one row of fasteners 12 is loaded, the user overcomes the elastic forces of the elastic members 462 to pull the movable assembly 40 backward. The movable assembly 40 moves to the third position. As shown in FIGS. 15 and 16, the user moves the movable assembly 40 inward to the second position. The third opening 431 is connected to the first opening 322. In this case, the user can load one row of fasteners 12 into the third accommodation portion 43 through the first opening 322 and the third opening 431. In this manner, the magazine 30 accommodates two rows of fasteners 12 in total. In this case, the user operates the lifting member 60 to make the row of fasteners 12 loaded later closely arranged in the third accommodation portion 43, and the row of fasteners 12 loaded later enters the working state. The row of fasteners 12 loaded later moves in one movable channel 102 formed by the third accommodation portion 43 and the magazine body 31. The fasteners 12 are driven out in sequence. After all the fasteners 12 in the row of fasteners 12 loaded later are consumed, the user pulls the lifting member 60 (which drives the fasteners 12 to move above the magazine 30) below the magazine 30. As shown in FIGS. 13 and 14, the user operates the locking assembly 46, and the locking assembly 46 enters the unlocking state. The locking assembly 46 allows the user to move the movable assembly 40 to the first position. When the movable assembly 40 is at the first position, the second opening 421 is connected to the first opening 322. The row of fasteners 12 loaded first enters the working state from the standby state, and the lifting member 60 makes the row of fasteners 12 loaded first closely arranged in the second accommodation portion 42. The row of fasteners 12 loaded first moves in one movable channel 102 formed by the second accommodation portion 42 and the magazine body 31. The fasteners 12 are driven out in sequence. After all the fasteners 12 in the row of fasteners 12 loaded first are consumed, the two rows of fasteners 12 are all consumed.

The magazine 30 is also suitable for pneumatic fastening tools. The pneumatic fastening tool is driven by high-pressure gas to operate. In some examples, the pneumatic fastening tool does not include a motor. In some examples, the pneumatic fastening tool does not include a battery pack. The specific structure of the fastening tool for which the magazine 30 is suitable is not limited here, and the fastening tool may be powered by fuel.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A fastening tool, comprising:
a striking assembly comprising a striker that strikes a fastener of a plurality of fasteners;
a transmission assembly that drives the striker to move;
a housing supporting the transmission assembly;
a motor at least partially disposed in the housing; and
a magazine accommodating the plurality of fasteners, the magazine comprising at least two movable channels in which at least some of the plurality of fasteners move.

2. The fastening tool of claim 1, wherein the at least two movable channels at least partially overlap in a front and rear direction.

3. The fastening tool of claim 1, wherein the magazine comprises a magazine body and a movable assembly that separates the at least two movable channels.

4. The fastening tool of claim 3, wherein the movable assembly is movably connected to the magazine body.

5. The fastening tool of claim 4, wherein the movable assembly comprises a separator and a locking assembly, and the locking assembly allows the separator to be switched between a first position and a second position relative to the magazine body.

6. The fastening tool of claim 4, wherein at least some of the plurality of fasteners move together with the movable assembly relative to the magazine body.

7. The fastening tool of claim 3, wherein the magazine body comprises a first opening, the movable assembly comprises a second opening and a third opening, and the movable assembly is operable by the user to selectively connect the second opening and the third opening to the first opening.

8. The fastening tool of claim 3, wherein the movable assembly is connected to the magazine body through elastic members.

9. The fastening tool of claim 1, further comprising a fastener holder for guiding the plurality of fasteners to move along a first straight line, wherein the fastener holder is selectively connected to one of the at least two movable channels so that the striker is capable of striking the fastener of the plurality of fasteners.

10. The fastening tool of claim 1, further comprising a lifting member, wherein the fastener of the plurality of fasteners has a working state, and in the working state, the lifting member drives the fastener of the plurality of fasteners to move in at least one of the at least two movable channels.

11. The fastening tool of claim 1, wherein the at least two movable channels are parallel to each other.

12. The fastening tool of claim 1, further comprising a power interface coupled to the motor and connectable to a battery pack.

13. The fastening tool of claim 1, wherein a length of the magazine in a front and rear direction is greater than or equal to 163 mm and less than or equal to 245 mm.

14. The fastening tool of claim 5, wherein the locking assembly is driven by elastic forces to move.

15. The fastening tool of claim 3, wherein the movable assembly comprises a separator, and the separator comprises a second accommodation portion and a third accommodation portion for accommodating the plurality of fasteners.

16. A fastening tool, comprising:
a striking assembly comprising a striker that strikes a fastener of a plurality of fasteners;
a transmission assembly that drives the striker to move;
a housing supporting the transmission assembly;
a motor at least partially disposed in the housing;
a magazine accommodating the plurality of fasteners;
a fastener holder, that guides the plurality fasteners along a first straight line, having an input port connected to at least a part of the magazine;
a lifting member that drives the fastener of the plurality of fasteners to move so that the fastener of the plurality of fasteners passes through the input port, wherein the fastener of the plurality of fasteners has a working state in which the fastener of the plurality of fasteners is subjected to a force from the lifting member and a standby state in which the fastener of the plurality of fasteners is not subjected to the force from the lifting member; and
a movable assembly that drives at least the fastener of the plurality of fasteners to switch to the working state.

17. The fastening tool of claim 16, wherein the magazine comprises at least two movable channels in which at least some of the plurality of fasteners move.

18. The fastening tool of claim 17, wherein the at least two movable channels at least partially overlap in a front and rear direction.

19. The fastening tool of claim 16, wherein the magazine comprises a magazine body and the movable assembly that separates at least two movable channels.

20. A magazine for a fastening tool, wherein the magazine accommodates a plurality of fasteners and comprises at least two movable channels in which at least some of the plurality of fasteners move.
